(19) United States
(12) Patent Application Publication
(10) Pub. No.: US 2015/0227902 A1
(43) Pub. Date: Aug. 13, 2015

(54) SPECIALIST PRESENTATION

(71) Applicant: BANK OF AMERICA CORPORATION, Charlotte, NC (US)

(72) Inventors: Peter John Bertanzetti, Charlotte, NC (US); Kevin T. Cole, Charlotte, NC (US); Carrie Anne Hanson, Charlotte, NC (US); Elizabeth S. Votaw, Potomac, MD (US); Joseph Neil Johansen, Rock Hill, SC (US)

(73) Assignee: BANK OF AMERICA CORPORATION, Charlotte, NC (US)

(21) Appl. No.: 14/175,045

(22) Filed: Feb. 7, 2014

(51) Int. Cl. G06Q 20/10; H04L 29/08; H04L 12/18

(52) U.S. Cl. CPC G06Q 20/108; H04L 12/1813; H04L 67/06; H04L 67/306; G06Q 40/02

(57) ABSTRACT

Embodiments of the invention provide a specialist presentation tool that presents a specialist from an institution to a user in a website or application the user is viewing, an application running in the background of a user system, or through a communication channel. The specialist may be presented to the user based on triggers that occur when the user takes actions, or when actions are taken with respect to a user account. The determination of the one or more specialists to present to a user from a group of specialists that satisfy a trigger may be based on one or more conditions that match the specialist with the user. The conditions may include but are not limited to locations of the user and specialists, profile information of the user and specialists, social networking contacts for the user and specialists, or other like account profile information for the user and specialists.

### FIELD

This invention relates generally to the field of matching users (e.g., customers, clients, or the like) with specialists, and more particularly embodiments of the invention relate to apparatuses and methods for presenting customized specialists to the users.

### BACKGROUND

Determining ways of matching customers with specialists in a manner that efficiently increases the chances that the customers utilize the products (e.g., goods and services) provided by the specialists helps to improves the customer service of a business.

### BRIEF SUMMARY

Embodiments of the present invention address the above needs and/or achieve other advantages by providing apparatuses (e.g., a system, computer program product, and/or other device) and methods that help present specialists to a customer in a customized way to provide the customer with improved service.

Embodiments of the invention provide a specialist presentation tool (e.g., application, program, software, or the like) that works in conjunction with an online banking application, a website, another application, a communication channel, or runs a portion of an application on a user computer system. The specialist presentation tool presents a specialist from an institution to a user in a digital environment, or other like environment. As described herein, a user may be a customer of an institution (“customer” or “client” may be used interchangeably within this specification). The institution may be a financial institution, or any other type of institution that presents recommendations of specialists to a user. In the example when the user is as customer of a financial institution, the specialist may be, but is not limited to a financial solutions advisor (hereinafter “FSA”), loan officer, account manager, or other like financial institution advisor. The specialist may be presented to the user based on triggers that occur when the user takes actions, or when actions are taken with respect to a user account. The triggers may comprise a threshold level of net worth, assets with the institution (e.g., number or amount), assets with multiple institutions, deposits into user accounts, payments made from user accounts, stock sales or purchases, transactions entered into with a particular merchant, or other like triggers specifically described herein or not specifically described herein. Other triggers include determining when the user selects or searches for a product within an online banking application, over a website, at an automated teller machine (ATM), at device at a physical teller, within an application running on a user computer system, or the like. The triggers may determine when to present a specialist and what type of specialist to present (e.g., FSA, mortgage, or the like).

The determination of the one or more specialists to present to a user from a group of specialists (e.g., a FSA group) that satisfy the trigger may be based on one or more conditions that match the specialist with the user. The conditions may include but are not limited to locations of the user and specialists, profile information of the user and specialists, social networking contacts or information for the user and specialists, or the like. The location condition (e.g., geographic area, county, city, region, area code, radius, distance, or the like) may include the location of the user with respect to the location of the specialists in order to determine one or more specialists that are available to work with the user (e.g., in the same geographic area, county, city, region, area code, radius, distance, within “X” miles from each other, or the like).

The social networking account contacts of the user may also be a condition used to suggest specialists to the users. In one embodiment the specialists may be presented to the user based on the contacts within the user's one or more social networking accounts that have a relationship (e.g., worked with, used in the past, used recently, provided favorable ratings or endorsements to, provided a recommendation for, or the like) with the specialists (hereinafter described as “common contacts” or “common connections” interchangeably). In some embodiments, the specialists with the most common contacts with the user are presented to the user. In other embodiments the specialists may be presented to the user along with information indicating that contacts in the user's social networking account may use the specialist for various products, endorse the specialist, or recommend the specialist. For example, when a specialist works with five clients (or any other number of clients) that are contacts with a first user over a social networking account, the specialist may be presented to the first user as a suggested specialist. The number of common contacts (e.g., 5, or other like number) may also be presented to the first user, or in some embodiments the names of the contacts (e.g., client 1, client 2, client 3, or the like) may be presented to first user with authorization from the clients. In other embodiments, the number of endorsements (e.g., likes, or other indicator of approval) received by the specialist from the contacts may be presented to the first user along with the specialist. In addition the types of products (e.g., insurance, mortgage, investment accounts, or the like) that the common contacts use from the specialist could also be presented to the first user with authorization from the clients.

Moreover, social networking account information (e.g., user profile information), or other profile information, may also be a condition for matching specialists to users. For example, when the specialist and the user attended the same school, previously lived in the same city, have the same interests, or the like, the specialist may be presented to the user as a suggest specialist.

The presentation of the specialist may occur at a point in time in which the user is most likely interested in receiving information or having a conversation with a specialist (e.g., when the user receives a bonus). The presentation of the specialist may include the presentation of the specialist's name, the specialist's expertise, a profile of the specialist providing information about the specialist, or the like. The presentation of the specialist may include or allow for access to a pre-recorded video from the specialist related to a product in which the user may be interested. The user and specialist may set up an appointment by adding a meeting notice to the calendars of the user and/or the specialist. In other embodiments of the invention the presentation of the specialist may occur when an annual review (e.g., or other time interval review) is due for accounts owned by the user. Moreover, the user may be able to subscribe to a specialist feed (e.g., newsletter, blog, or the like) to receive ongoing information from the specialist or receive facts regarding the specialist.

Embodiments of the invention comprise systems, computer program products, and methods for presenting a specialist within an institution to a user (e.g., a customer of the institution). One embodiment of the invention comprises identifying a trigger for a user; identifying a condition for associating one or more specialists with the user; identifying a specialist based on the trigger and the condition; and presenting an indication of the specialist to the user.

In further accord with an embodiment of the invention, presenting the indication of the specialist to the user comprises presenting the indication of the specialist in the website in which the user is viewing.

In another embodiment of the invention, presenting the indication of the specialist to the user comprises presenting the indication of the specialist in an application downloaded to a user computer system.

In yet another embodiment of the invention, presenting the indication of the specialist to the user comprises sending an alert to the user through an application that is at least partially located on a user computer system.

In still another embodiment of the invention, identifying the condition for associating one or more specialists with the user comprises identifying a user profile of the user, and identifying a specialist profile of the specialist, and wherein identifying the specialist is further based on the user profile and the specialist profile.

In further accord with an embodiment, the invention comprises receiving an indication from the user to view specialist information for the specialist, and presenting the specialist information to the user in a specialist profile interface.

In another embodiment, the invention comprises receiving an indication from the user to initiate a communication with the specialist, and notifying the specialist of the indication from the user.

In yet another embodiment of the invention, the trigger comprises at least one of receiving a deposit into a user account, reaching a threshold level of net assets, reaching a threshold level associated with the accounts, identifying a search the user is performing within the online banking application, receiving a request for information made by the user, entering stock transactions, identifying a transaction with an institution, or identifying a payment made to another institution.

In still another embodiment of the invention, the condition comprises at least one of a user location compared to a specialist location, user profile information compared to specialist profile information, social networking contacts of the user associated with the specialist, or expertise of the specialist as it relates to the product in which the user is interested.

The features, functions, and advantages that have been discussed may be achieved independently in various embodiments of the present invention or may be combined in yet other embodiments, further details of which can be seen with reference to the following description and drawings.

### BRIEF DESCRIPTION OF THE SEVERAL VIEWS OF THE DRAWINGS

Having thus described embodiments of the invention in general terms, reference will now be made to the accompanying drawings, wherein:

FIG. 1 illustrates a high level process flow for a specialist presentation process, in accordance with one embodiment of the present invention;

FIG. 2 illustrates a specialist presentation process for an online banking account, in accordance with one embodiment of the present invention;

FIG. 3 illustrates a specialist presentation process utilizing a social networking account of the user, in accordance with one embodiment of the present invention;

FIG. 4 illustrates a online banking interface with a specialist presentation section, in accordance with one embodiment of the present invention;

FIG. 5 provides a specialist profile interface, in accordance with one embodiment of the present invention; and

FIG. 6 provides a block diagram illustrating a specialist presentation system environment, in accordance with one embodiment of the present invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout. Although some embodiments of the invention described herein are generally described as involving a “financial institution” or “bank,” one of ordinary skill in the art will appreciate that other embodiments of the invention may involve other businesses or institutions that take the place of or work in conjunction with the financial institution or bank to perform one or more of the processes or steps described herein as being performed by a financial institution or bank. Still in other embodiments of the invention the financial institution or bank described herein may be replaced with other types of businesses or institutions that offer account services to customers.

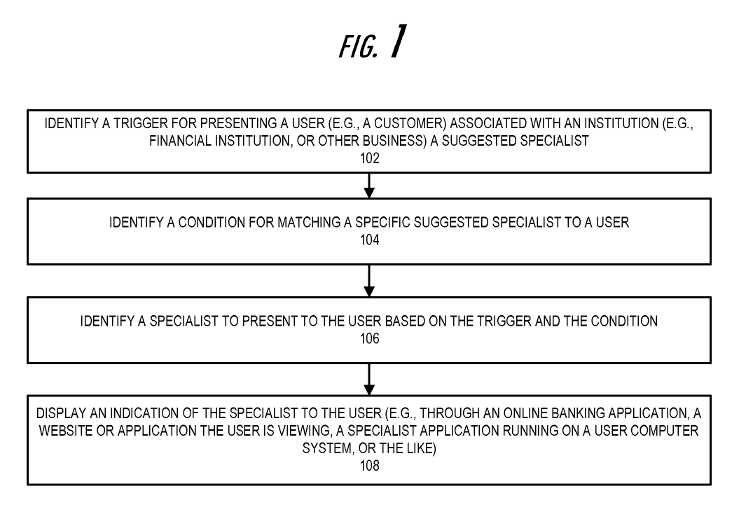

FIG. 1 illustrates a high-level process flow for a specialist presentation process 100. As illustrated by block 102 in FIG. 1, the specialist presentation system 1 (e.g., using a specialist presentation tool) identifies a trigger for a user 9 associated with an institution. For example, a customer may have accounts with a financial institution and the trigger may be related to activity for the accounts. As will be described in further detail later, with respect to a financial institution the trigger may comprise a threshold level of net worth, assets with the institution, assets with multiple institutions, payments made to other institutions, deposits made into user accounts, stock sales or purchases, transactions entered into with a particular merchant, or the like. The trigger may also be based on a product that the user 9 is searching or viewing in an online banking application 17, another website, through an application, through an ATM, at device at a physical teller, or the like. For example, again with respect to a financial institution, the user 9 may be searching information for a mortgage, for opening an investment account, for life insurance, or the like.

As illustrated by block 104 in FIG. 1, the specialist presentation system 1 identifies one or more conditions for matching a specific specialist 7 with a specific user 9. In some embodiments of the invention, as described in further detail later the conditions may include a location of the residence, work, or the like of the user 9 proximate to the location of the specialist 7. The conditions may further include the expertise of the specialist 7 as it relates to the perceived or actual product in which the user 9 is interested. The conditions may also be based on information from a social networking account of the user 9, such as but not limited to the user's contacts, profile information, content in which the user is interested, or the like. The conditions may also be based on other profile information from other sources, such as but not limited to a profile of the user for the user's banking accounts, e-mail accounts, or other like profile information.

As illustrated by block 106 in FIG. 1, the specialist presentation system 1 identifies a specialist 7 based, at least in part, on one or more triggers and one or more conditions. Then the specialist presentation system 1 displays an indication of the specialist 7 to the user 9, as illustrated by block 108 in FIG. 1. The indication of the specialist 7 may be a portion of a specialist profile (e.g., a specialist name, photo, information, or the like), may be the entire profile of the specialist 7, or may be an indication of a potential specialist 7 that requires the user 9 to take an action before the specialist 7 is presented (e.g., an icon, link, or the like). As discussed in further detail later, the indication of the specialist 7 may be displayed within an online banking account 17 of the user 9, in a website the user 9 is viewing, in an application the user 9 is viewing, through a communication channel (e.g., text message, instant message, chat feature, or any other type of communication channel), through a dedicated specialist presentation application running on a user computer system, through an ATM that the use is using, on a device associated with a physical teller, or other like notification channel. Moreover, as explained in further detail later the user 9 may take actions on the presentation of the specialist 7 in order to view additional information (e.g., specialist profiles) regarding the specialist, view videos from the specialist, communicate with the specialist 7, schedule a meeting with the specialist 7, or perform another like action.

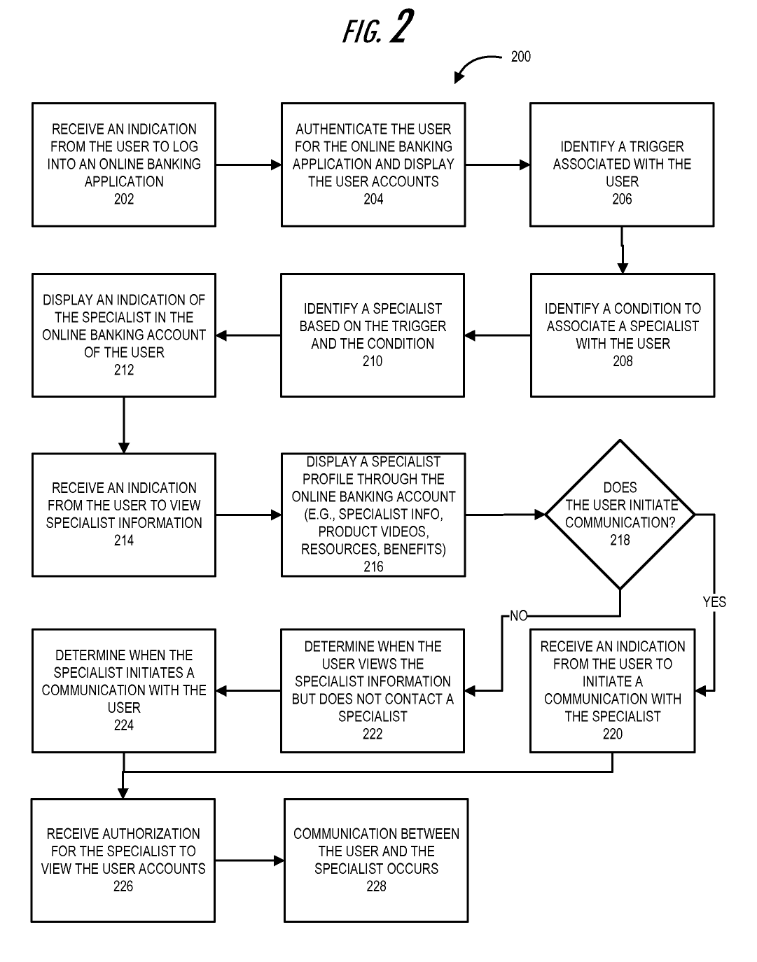

FIG. 2 illustrates a process flow for a specialist presentation process 200 in accordance with one embodiment of the invention wherein the user 9 is a customer of a financial institution and the specialist 7 is an employee, contractor, or the like of the financial institution or associated institution. As illustrated by block 202, the financial institution receives an indication from the user 9 to log into on online banking application 17. In return, the financial institution authenticates the user 9 for access to the online banking application 17 and displays an accounts interface, a portfolio interface, or another like interface to the user, as illustrated by block 204 in FIG. 2.

Block 206 of FIG. 2 illustrates that the financial institution identifies a trigger associated with the user 9, which would facilitate presenting a specialist 7 to the user 9. In one embodiment a trigger may comprise a product that the user 9 is searching for within the user's online banking account (or in other embodiments of the invention within a website or another application). For example, a user 9 may enter a keyword search for investment information regarding an investment account, loan information for a mortgage, or another type of action related to an account of the user 9 or a product provided by the financial institution. In another embodiment the trigger may comprise a product that user 9 identifies by selecting links within the online banking application 17 (or in other embodiments of the invention within a website or another application). For example, a user 9 may select an image, hyperlink, advertisement, or the like within an interface that relates to an account of the user 9 or a product provided by the financial institution.

In other embodiments of the invention, the trigger may be specific to receiving a presentation of a specific specialist 7, such as an FSA specialist. For example, a user 9 may achieve a threshold level of net assets with the institution and in response may trigger a presentation of one or more FSAs to the user 9. Other specific triggers for an FSA may include the user 9 reaching a threshold level of assets (e.g., number of accounts, total amount in the accounts, or the like) with the institution. In other embodiments the financial institution may be able to determine assets that the user 9 has with multiple institutions, such that a threshold level of assets that would result in a trigger may include a determination of assets across multiple institutions. This situation may occur when the user incorporates the user's accounts from other institutions into an online banking account of a primary institution, such as when the user provides the account number and password for accounts at other institutions and the primary institution accesses the accounts and displays information about the outside accounts alongside the primary institution accounts. Alternatively, the outside account information may be determined by performing a financial worthiness check, or through partnerships with other institutions. The trigger may also be based on an influx of a threshold level of cash or other assets into one or more accounts of the user, a sale or purchase of stock, or the like. For example, during a bonus period the user 9 may deposit an amount of money into an account that may trigger a presentation of an FSA that can help invest the money for the user 9.

In other embodiments of the invention the triggers may be based on payments that the user 9 makes to institutions, or transaction history for transactions the user 9 enters into with institutions. For example, the user 9 may make a payment for a mortgage to another institution, which may trigger the presentation of a loan officer specialist 7 to discuss refinancing options with the user 9. In another example, the user 9 may make a payment to an institution for life insurance or other insurance, which may trigger the presentation of an insurance specialist 7 to discuss insurance options with the user 9. In another example, the user may make a payment to an institution for school loans, which may trigger the presentation of a financial aid specialist 7 to discuss loan payment options with the user 9. In yet another embodiment, the user 9 may enter into a transaction to purchase baby related products, which may indicate that the user is having a child, and thus the transaction may trigger the presentation of a financial advisor specialist 7. The payment or transaction information may be determined based on payment or transaction records that are incorporated directly or indirectly into a payment application or transaction application within an online banking account, such as payments made with a user account, statements that may be automatically incorporated from other institutions, information that is manually incorporated by users 9, or other like means.

Based on the triggers associated with specialist types, a group of specialists 7 may be identified that could be presented to the user 9. In some embodiments one or more specialists 7 from the group of specialists identified are presented to the user 9. However, in some embodiments the group of specialists may be further narrowed down in other ways to provide more customized specialists 7 to the user 9.

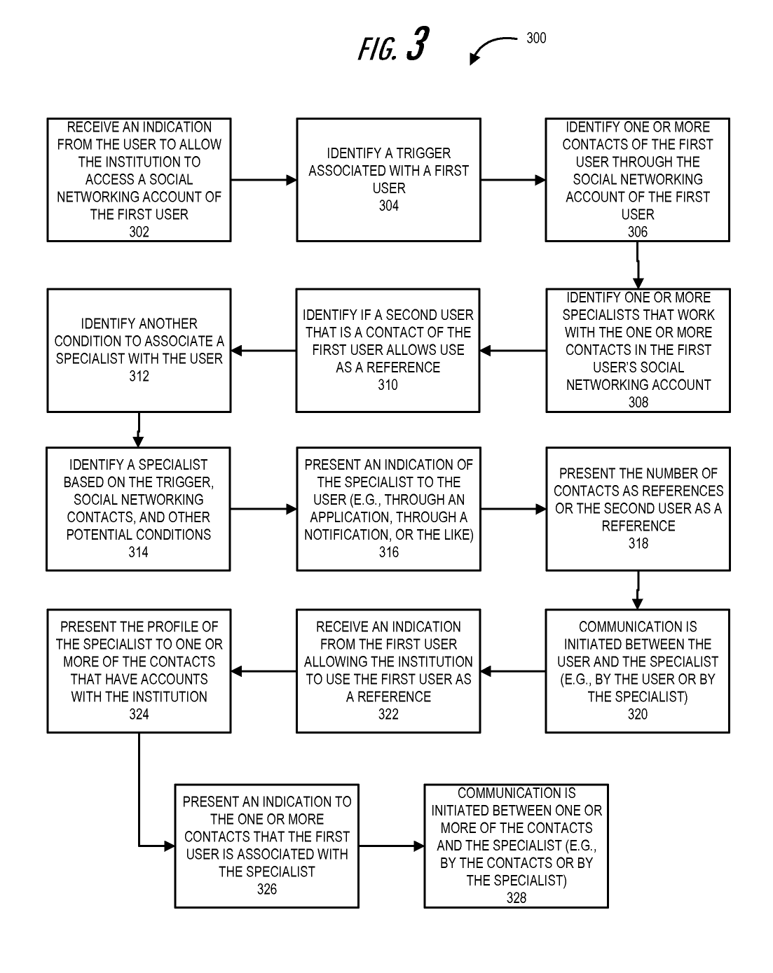

As illustrated by block 208, in some embodiments of the invention after a trigger is identified, the financial institution identifies one or more conditions for presenting one or more specialists 7 from the group of specialists. For example, a condition may be the location of the user 9 (e.g., home, residence, route of the user, current location, or the like) with respect to a location of the specialist 7, such as within the same city, town, area, zip code, within ‘X’ miles from each other, or the like. Another condition may include information that may be identified from the social networking accounts that the user 9 allows the institution to access, as will be explained in further detail later with respect to FIG. 3. The social networking information may include common contacts between the user 9 and specialist 7, or profile information of the user. The profile information from the user's profile in social networking accounts, or other user profiles from other applications (e.g., the online banking application, online shopping applications, online gaming profiles, e-mail profiles, or the like), may be information that illustrates where the user 9 has lived, the user's education, interests, age, company, or the like, which can be compared with the same information from the specialists 7 to aid in identifying one or more specialists 7 to present to the user 9. For example, if the user 9 works for Company A, the specialist 7 that is a dedicated specialist for Company A may be presented to the user 9, and furthermore, if discounts are provided for employees of Company A (or for any other satisfied condition) the discounts may be presented along with the specialist as the specialist 7 is presented to the user 9. Additional conditions may include matching the net worth or assets of the user 9 with specialists 7 that handle clients with a similar net worth or assets (e.g., within a range of each other).

As illustrated by block 210 in FIG. 2, the financial institution identifies one or more specialists 7 to present to the user 9 based on the trigger and/or the conditions. For example, the trigger may be a user 9 selecting a link related to investment material and one of the one or more conditions may be identifying an FSA that is located within ten (10) miles of the location of the user's work. As such, the institution identifies the one or more specialists 7 that have an expertise in the investment material in which the user 9 is interested, and are also located within ten (10) miles of the location at which the user 9 works.

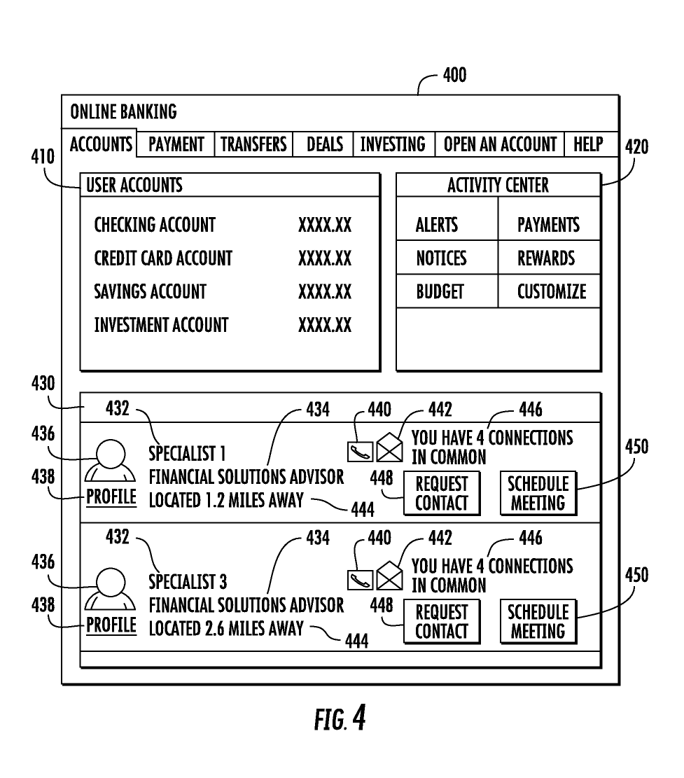

Block 212 of FIG. 2 illustrates that the institution displays an indication of the one or more specialists 7 in the online banking account of the user 9 (or in other websites or applications outside of the online banking account). In some embodiments of the invention the indication of the specialist 7 may include providing an image of the specialist 7 along with specialist information within the online banking application 17, or other website or application outside of the online banking application 17, which is discussed in further detail below. FIG. 4 illustrates one embodiment of an online banking interface 400 in which the one or more specialists 7 may be presented to the user 9. FIG. 4 has an accounts section 410, an activity center 420, and a specialist 7 presentation section 430 in accordance with one embodiment of the invention. The accounts section 410 may include the one or more accounts that the user 9 has with the financial institution, such as a checking account, credit card accounts, savings accounts, investment accounts, or other like accounts. The activity center section 420 may provide information related to alerts, payments, notices, rewards, budgets, customized information, or other like information related to the user accounts with the financial institution. The specialist presentation section 430 may include information regarding the one or more specialists 7 that meet the triggers and/or conditions identified by the financial institution. As illustrated, the specialist presentation section 430 may include the specialist name 432, specialist title 434, specialist picture 436, specialist profile link 438, specialist phone contact 440, specialist e-mail contact 442, other specialist contact information, distance of the specialist from the user 444, and as discussed in further detail later the number of social media connections 446 between the user 9 and the specialist 7, names of the connections, or other like connection information.

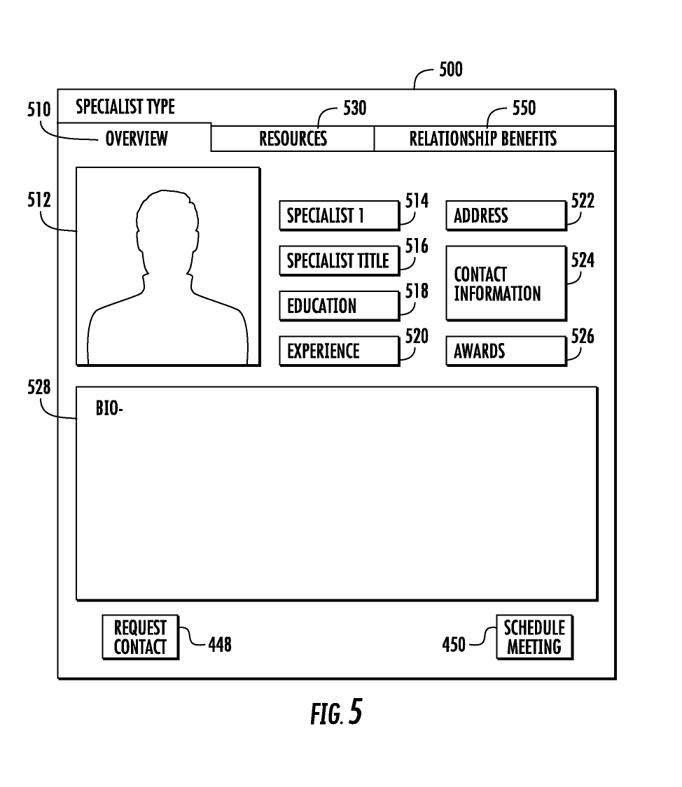

As illustrated by block 214 of FIG. 2 the financial institution receives an indication from the user to view specialist information. For example, the user 9 may select the profile link 438 in order to view additional information about the specialist 7. In response, as illustrated by block 216 in FIG. 2, the financial institution may display a specialist profile interface 500 through the online banking account (or other website or application in other embodiments of the invention). FIG. 5 illustrates a specialist profile interface 500, which in one embodiment may include an overview section 510, a resources section 530, and a relationship benefits section 550. As illustrated in FIG. 5, the overview section 510 may include a specialist picture 512, the specialist name 514, the specialist title 516, the education of the specialist 518, the experience of the specialist 520, the specialist address 522, the specialist contact information 524, awards 526 received by the specialist 7, and a specialist bio section 528. The resource section 530 may provide tools or other information related to financial planning, or other products, which the user 9 can utilize. The relationship benefits section may include information regarding the benefits that the user 9 may have access to if the user utilizes the services of the specialist 7. In some embodiments of the invention the specialist 7 may have pre-recorded videos for the user 9, such as videos discussing the specialist's profile information, products that are offered by the institution, or resources and tools that the user 9 may have access to if the user 9 utilizes the specialist 7 or uses products from the institution.

As illustrated by decision block 218, a determination is made if the user 9 decided to initiate a communication with the specialist 7. As illustrated in block 220, the user 9 may initiate a communication, which may comprise calling the specialist 7 over the phone, sending the specialist 7 an e-mail communication, sending an instant message communication, making a video call to the specialist 7, sending a text message, or initiating any type of communication through a communication channel. In one embodiment of the invention, the specialist 7 may be communicating with other clients, and as such the user 9 may have to leave a message for the specialist 7. In some embodiments, initiating the communication includes when user 9 makes a selection indicating that the user 9 requests and approves contact from the specialist 7, and as such the specialist 7 is notified to contact the user 9. For example, the user 9 may select a request contact feature 448 in the specialist presentation section 430 or the specialist profile interface 500, and the specialist 7 receives notification to contact the user 9. In some embodiments, the user 9 may also be able to request the communication channel through which the user 9 wishes to receive the communication from the specialist 7. In other embodiments of the invention, the user 9 may select a schedule meeting feature 450 in the specialist presentation section 430 or the specialist profile interface 500, and a specialist calendar may be provided to the user 9 to request a particular date and time on which to meet in person or have another type of communication over another communication channel.

Returning to block 218, the user 9 may not initiate the communication. As illustrated by block 222, a determination is made when the user 9 views the profile of the specialist 7 or otherwise provides an indication of interest in the specialist 7 without contacting the specialist 7. For example, other then viewing a profile of specialist 7, the indication of interest may include selecting a feature indicating that the user would like more information from the specialist 7, selecting a feature for information about a particular product through the specialist 7, selecting information provided by the specialist 7 on the profile (e.g., news articles posted by the specialist 7 or financial tools suggested by the specialist 7), or the like. As illustrated by block 224, when the determination is made that the user 9 has provided an indication of interest, the specialist 7 may initiate a communication with the user 9 in the same or similar ways as was described with respect to the user 9 initiating the communication with the specialist 7.

Before the communication occurs, regardless of who initiated the communication, as illustrated by block 226, the specialist 7 may receive authorization from the user 9 to view the user accounts to gather information. For example, the notification from the user 9 to the specialist 7 requesting communication may also include approval from the user 9 to allow the specialist 7 to view the accounts of the user 9, and to provide customized communication regarding the user accounts before or during the communication. In other embodiments the initiation of the communication from the specialist 7 may also include a request from the specialist 7 to view the user's accounts, which the user 9 may accept or decline prior to the communication. In some embodiments, the request may occur during the communication instead of before the communication. As illustrated by block 228, the communication between the specialist 7 and user 9 occurs.

In some embodiments of the invention, when a trigger occurs the specialist presentation system 1 may determine if the user 9 already has a dedicated specialist 7 for products associated with the trigger. The dedicated specialist 7 may be a specialist 7 that has previously worked with the user 9 or that otherwise has a relationship with the user 9. In the situations where the user 9 has a dedicated specialist 7 the specialist presentation system 1 may present the dedicated specialist 7 to the user 9 when a trigger occurs, when a follow up with the user 9 may be needed, or in another like scenario. For example, in some embodiments if the user 9 has a dedicated investment specialist 7 for an investment account that has yearly or quarterly reviews, the specialist presentation system 1 may present the dedicated specialist 7 the user 9 in order to remind the user 9 to set up the yearly or quarterly meetings. Instead of the specialist 7 having to call the user 9 repeatedly to set up the meeting the user 9 may be reminded to set up the meeting automatically on the user's own terms without the specialist 7 having to provide regular reminders.

In some embodiments of the invention the specialist presentation system may also incorporate information from one or more of the user's social networking accounts. As illustrated in block 302 of FIG. 3, the institution may receive an indication from the user 9 to allow the institution to access a social networking account of the user 9. For example, in the case of a financial institution, in the user's preferences (e.g., in the user's online banking account preferences) the user may indicate that the financial institution may access the user's social networking account to access connection information (e.g., information about the user's contacts), profile information, photos, or other types of information. For example, the user 9 may allow the institution to access the user's professional social networking account (e.g. for business contacts, or the like), personal social networking account (e.g., for personal contacts, or the like), messaging social networks, or any other type of social networking account. In particular, the user's professional social networking account used for business contacts may be helpful in identifying the user's contacts that may have a relationship with the specialist 7 (e.g., use services from the specialist 7) as described herein. In other embodiments of the invention, the user 9 may be prompted within a website or another application other than an online banking application regarding if the user 9 will allow access to the user's social networking account.

In still other embodiments, the institution may gain access to the user's social networking account by becoming a contact of the user 9. For example, if the user 9 and the institution are contacts over a social network the institution may have access to the names of the user's contacts. In some embodiments the user 9 may sign into a website or application using a name and password of a social networking account, and thus, the website or application may have access to information from the user's social networking account. For example, the user 9 may sign into media websites that are affiliated with the social networking account, and thus, the media websites may have access to the user's social networking information. In other embodiments of the invention user 9 may have a public social networking account or set preferences within a social networking account that allows one or more applications or websites to access the social networking account of the user 9, and thus, permission to access the social networking account of the user 9 may not be required.

As illustrated by block 304 in FIG. 3, the institution may identify a trigger associated with a first user 9, as previously discussed herein. The institution may also identify one or more contacts of the first user 9 through the social networking account of the first user 9, as illustrated by block 306. In some embodiments this may include identifying all of the user's contacts, a portion of the user's contacts, or a single contact. The contacts identified in the user's social networking account may be limited to contacts in the same or similar location as the user 9 or specialist 7, such as but not limited to the same geographic area, county, city, town, region, area code, radius, distance, or the like. The contacts may also be identified based on other information such as type of work, company for which the contact works, interest of the contact (e.g, company, people, news that the contact follows, likes, comments on, or the like).

As illustrated in block 308, of the one or more contacts identified (e.g., all contacts or a limited number of contacts from the social networking account of the user 9) the institution identifies one or more specialists 7 that have worked with the one or more contacts or otherwise have a relationship with the one or more contacts. For example, after retrieving the name and/or other information (e.g., location, school, company, or the like) of the contacts in the social networking account of the first user 9, the institution may identify one or more specialists 7 that have worked with the one or more contacts in the past. For example, the names and/or other information may be compared against the records of the institution, such as the financial institution, in order to determine the contacts that are also clients of one or more of the specialists 7.

As illustrated by block 310, the institution identifies if a second user (or multiple second users) identified as a contact of the first user has agreed to allow the institution to use the second user as a reference. In one embodiment, during the course of interactions between the specialists 7 and the clients, the clients (e.g., first user, second user, or other users) may authorize the institution to use the clients as references for other potential clients. In other embodiments, the clients may endorse the specialist by providing an indication (e.g., a like feature, a service endorsement feature, tag feature, or the like) that indicates that the client was happy with the service provided by the specialist 7. The endorsement may be created and stored by the social networking account, or may be created and stored within the financial institution systems (e.g., the online banking account), or both. In other embodiments of the invention, after identifying the contacts in the social networking account of the first user that are also clients of the institution, the institution may communicate with the contacts (e.g., second user, or multiple second users) and ask for permission to use the contacts as references, either generally (e.g., for any potential client) or specifically for the first user. In some embodiments of the invention if the clients that are contacts of the first user agree to be used as references (e.g., provide recommendations or endorsements), then the clients may receive discounts, products, promotions, or the like from the institution.

As explained in further detail later, when the contacts agree to be used as references the number of contacts of the first user 9 that are associated with the specialists 7, or in some embodiments of the invention, the name of one or more of the contacts may be displayed to the user 9.

As illustrated block 312, the institution identifies one or more other conditions for associating the user 9 and the specialist 7, as was previously discussed with respect to block 208 of FIG. 2. As previously discussed, the conditions may include the location of the user 9 and specialist 7. In other embodiments of the invention the conditions may be information from the profile of the user 9 based on an online banking profile, a social networking profile, or a profile of another application. As illustrated by block 314, the financial institution may identify one or more specialists 7 to present to the user 9 based on the trigger, the social networking contacts of the first user, and/or other conditions. In one embodiment, the specialists 7 that meet the social networking contact criteria or the condition criteria may be independent from each other. In other embodiments of the invention, the specialists 7 that meet the condition criteria may be determined from the one or more specialists 7 identified as contacts through the social networking account as described in block 308. As an example of determining a specialist 7 based on a condition using the social networking account, the social networking account may include information about the city or state in which the user 9 grew up, attended school, or lived for a period of time. The specialist system 20 may identify any specialists 7 that grew up in the same location, attended the same school, or lived in the same location as the user 9 using the specialist profile information or other information stored by the institution regarding the specialists 7. The profile information of the user 9 can be compared to the same information about the specialists 7 in order to identify points of common interest between the user 9 and the specialists 7. The specialists 7 that meet these conditions may be presented independently to the first user, or may only be presented to the first user when these specialists 7 also are identified as contacts of the first user.

As illustrated by block 316, the institution presents an indication of the one or more specialists 7 that meet the trigger, have relationships with the contacts of the user 9, and/or meet the desired conditions associated with the user 9. For example, as previously discussed with respect to block 212 of FIG. 2 the specialist 7 may be presented to the user 9 in a website the user 9 is viewing, an application the user 9 is using, or on a user computer system that the user 9 is utilizing. For example, in one embodiment the specialist 7 may be displayed to the user in a manner similar to the way the specialist 7 was presented to the user 9 in the online banking application 17, as previously discussed with respect to FIG. 4.

As illustrated by block 318, along with the indication of the specialist 7, the institution may also present the number of contacts in the user's social networking account with which the specialist 7 has a relationship. For example, as illustrated in FIG. 4, the social media connections 446 may be displayed to the user (e.g., ‘you have 4 connections in common’, or the like) in an interface. The number of connections may be the connections from a single social network or multiple social networks. In the alternative, or in addition to the social media connections 446, the financial institution may provide one or more specific names of contacts from the user's social network that have a relationship with the specialist 7 and that allow being presented as a reference. As such, in some embodiments one or more names of the contacts may be presented to the user 9 in an interface, such as the online banking interface 400 or another like interface, with an indication that the one or more contacts recommend or endorse the specialist 7, or an indication that the one or more contacts work with (e.g., are a client of, use, or the like) specialist 7. In some embodiment, in addition to the names of the contacts other information about the contacts (e.g., contact information) may be presented along with the specialist 7, such as but not limited to the products that the contacts use with the specialist, recommendation quotes from the contacts (e.g., specific quotes drafted by the contacts for the specialists 7), links to communications with the contacts (e.g., through the social media accounts of the first user), or the like. Again, as previously discussed, the contact information provided along with the specialists 7 may have to be approved by the contacts before it is shared with the first user.

As illustrated by block 320 of FIG. 3, the institution may identify that the profile of the specialist 7 is viewed and/or a communication is initiated between the user 9 and the specialist 7, as was previously described with respect to blocks 214 to 228 in FIG. 2.

Block 322 illustrates that in some embodiments, the first user 9 may also allow the specialist 7 to use the first user 9 as a reference. For example, after the first user 9 works with the specialist 7, the first user 9 may agree to let the specialist 7 use the first user 9 as a reference for other potential clients. The first user 9 may update preferences in an application or respond to a reference or endorsement request from the specialist 7 in order to allow the specialist 7 to use the first user 9 as a reference.

As illustrated by block 324, the institution may present an indication of the specialist 7 and/or the specialist profile to one or more of the contacts of the first user 9 that have accounts with the institution, such as financial accounts at a financial institution. For example, the financial institution may identify the names or other information of the contacts of the first user 9 through the first user's social networking account and identify the contacts that have accounts with the financial institution. The financial institution may then present an indication of the specialist 7 to the contacts with accounts at the financial institution through a website, application, online banking application, user computer system, or other channel. For example, the financial institution may present the specialist 7 to a second user 9 (e.g., in an online banking account of the second user). Additionally, the financial institution may also include an indication to the one or more contacts of the first user 9 that the first user 9 is associated with the specialist 7 and/or endorses or recommends using the specialist 7, as illustrated by block 326 in FIG. 3. For example, along with the presentation of the specialist to the second user 9, an indication may be presented that the specialist 7 just formed a relationship with the first user 9 or the first user 9 just signed up for a product with the specialist 7.

As illustrated by block 328, the profile of the specialist is viewed and/or a communication is initiated and/or undertaken between the one or more contacts of the first user 9 (e.g., the second user 9) and the specialist 7 as was previously described with respect to blocks 214 to 228 described in FIG. 2.

In some embodiments of the invention, as previously described above, the financial institution may present a specialist 7 and/or a specialist profile to a user 9 on a user computer system 30 outside of an online banking application 17. For example, in one embodiment a user 9 may be searching for products through a search engine or another website unrelated to an online banking application 17 using a user computer system 30. A specialist application 27 may be utilized to present the specialist 7 in the website on the user computer system 30, in an application running on the user computer system 30, or through a portion of the specialist application 27 that may be located on the user computer system 30. With respect to the website, the user 9 may view products on the website and initiate a trigger. In response to the trigger, a specialist application 27 that is receiving information from the website identifies the trigger and presents a specialist 7 in a section of the website that may be specified for presenting information on a subscription or payment basis. The specialist 7 may be presented in the website in the same or similar manner as is described within this specification for the online banking application 17.

In some embodiments of the invention instead of a website, the user 9 may be using an application when initiating a trigger. In response, the specialist application 27 that is receiving information from the application the user 9 is using, identifies the trigger and presents a specialist 7 in a section of the application that may be specified for presenting information on a subscription or payment basis. The specialist 7 may be presented in the application in the same or similar manner as is described within this specification for the online banking application 17.

In some embodiments of the invention a portion of the specialist application 27 may be running on the user computer system 30 on a constant basis, during specific times, when activated by the user 9, or the like. The portion of the specialist application 27 running on the user computer system 30 may monitor the user 9 (e.g., with the permission of the user 9) and in response to a trigger may present an indication of a specialist 7 to the user 9 through a pop-up window, indicator icon, or other type of alert. The presentation of the indication of a specialist 7 may be accompanied by a notification of the trigger event. For example, in the case of assets with the financial institution, once the assets reach a threshold level an indication of the assets of the user 9 and the indication of the specialist 7 may be presented to the user 9 in a pop-up window on the user computer system 30. The specialist 7 may be presented in the application in the same or similar manner as is described within this specification for the online banking application 17.

In other embodiments of the invention, the specialist application 27 may run in the background of the specialist presentation system 1, such that when a trigger occurs the specialist presentation system 1 may alert or notify the user 9 of the specialist 7 through various communication channels, such as but not limited to text message, e-mail, instant message, application notification, or the like. The specialist 7 may be presented in the communication channel or may include a link to an interface that is used to display the specialist 7 in the same or similar manner as is described within this specification for the online banking application 17.

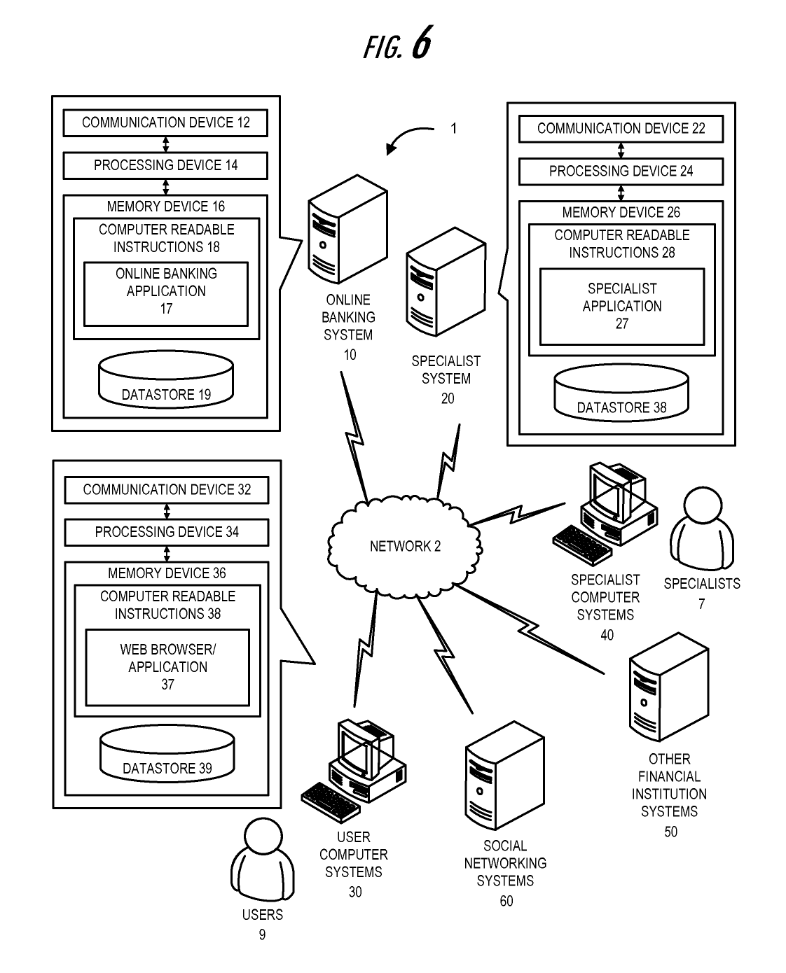

FIG. 6 illustrates a specialist presentation system 1 environment, in accordance with an embodiment of the present invention. As illustrated in FIG. 6, the online banking system 10 is operatively coupled, via a network 2 to the specialist system 20, user computer systems 30, specialist computer systems 40, other financial institution systems 50, and social networking systems 60. In this way, the online banking system 10 can receive and send information from and to the specialist system 20, user computer systems 30, specialist computer systems 40, other financial institution systems 50, and social networking systems 60, such that users 9 can receive specialist 7 suggestions either within an online banking application 17 or outside of an online banking application 17 through another application or website based on various triggers and conditions related to the user's accounts or actions. FIG. 6 illustrates only one example of embodiments of a specialist presentation system 1 environment, and it will be appreciated that in other embodiments one or more of the systems (e.g., computers, mobile devices, servers, or other like systems) may be combined into a single system or be made up of multiple systems.

The network 2 may be a global area network (GAN), such as the Internet, a wide area network (WAN), a local area network (LAN), or any other type of network or combination of networks. The network 2 may provide for wireline, wireless, or a combination of wireline and wireless communication between devices on the network.

As illustrated in FIG. 6, the online banking system 10 generally comprises a communication device 12, a processing device 14, and a memory device 16. As used herein, the term “processing device” generally includes circuitry used for implementing the communication and/or logic functions of a particular system. For example, a processing device may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities. The processing device may include functionality to operate one or more software programs based on computer-readable instructions thereof, which may be stored in a memory device.

The processing device 14 is operatively coupled to the communication device 12 and the memory device 16. The processing device 14 uses the communication device 12 to communicate with the network 2 and other devices on the network 2, such as, but not limited to, the specialist system 20, user computer systems 30, specialist computer systems 40, other bank systems 50, and social networking systems 60. As such, the communication device 12 generally comprises a modem, server, or other device for communicating with other devices on the network 2.

As further illustrated in FIG. 6, the online banking system 10 comprises computer-readable instructions 18 stored in the memory device 16, which in one embodiment includes the computer-readable instructions 18 of an online banking application 17. In some embodiments, the memory device 16 includes a datastore 19 for storing data related to the online banking system 10, including but not limited to data created and/or used by the online banking application 17. As discussed above the online banking application 17 allows the users 9 to access the user's accounts and received suggested specialists 7 based on the user's accounts and actions. The online banking system 17 described herein may be an online banking application accessed through a web browser, through an ATM, at a teller interface, through a mobile device application, through a web browser on a mobile device, or the like.

As further illustrated in FIG. 6, the specialist system 20 generally comprises a communication device 22, a processing device 24, and a memory device 26. The processing device 24 is operatively coupled to the communication device 22 and the memory device 26. The processing device 24 uses the communication device 22 to communicate with the network 2, and other devices on the network 2, such as, but not limited to, the online banking system 10, user computer systems 30, specialist computer systems 40, other financial institution systems 50, and/or social networking systems 60. As such, the communication device 22 generally comprises a modem, server, or other device(s) for communicating with other devices on the network 2.

As illustrated in FIG. 6, the specialist system 20 comprises computer-readable program instructions 28 stored in the memory device 26, which in one embodiment includes the computer-readable instructions 28 of a specialist application 27. In some embodiments, the memory device 26 includes a datastore 29 for storing data related to the specialist system 20, including but not limited to data created and/or used by the specialist application 27. The specialist application 27 stores the profiles of specialists 7 and allows them to be displayed to users through the online banking application 17 of the users 9, through other websites or applications used by the users 9, and/or on the user computer systems 30 (e.g., laptops, mobile devices such as smartphones or tablets, or the like) or on any other type of system utilized by the users 9 (e.g., ATMs, devices at the physical teller, or the like).

As further illustrated in FIG. 6, the user computer systems 30 generally comprise a communication device 32, a processing device 34, and a memory device 36. The processing device 34 is operatively coupled to the communication device 32 and the memory device 36. The processing device 34 uses the communication device 32 to communicate with the network 2, and other devices on the network 2, such as, but not limited to, the online banking system 10, specialist system 20, specialist computer systems 40, other financial institution systems 50, and/or social networking systems 60. As such, the communication device 32 generally comprises a modem, server, or other devices for communicating with other devices on the network 2, and a display, camera, keypad, mouse, keyboard, microphone, and/or speakers for communicating with one or more users 9. The user computer systems 30 may include, for example, a personal computer, a laptop, a mobile device (e.g., phone, smartphone, tablet, or personal display device (“PDA”), or the like) or other devices, or the like. In some embodiments, the user computer systems 30, such as a mobile device or other devices, could include a data capture device that is operatively coupled to the communication device 32, processing device 34, and the memory device 36. The data capture device could include devices such as, but not limited to an image capture device, wireless data capture device, location determine device, or other like device (e.g., radio frequency identification (“RFID”) device, global positioning satellite (“GPS”) device, or the like), which can be used by a user 9, institution, or the like to capture information from a user, such as but not limited to the location of the user.

As illustrated in FIG. 6, the user computer systems 30 comprise computer-readable program instructions 38 stored in the memory device 36, which in one embodiment includes the computer-readable instructions 38 of a web browser/application 37. In some embodiments, the memory device 36 includes a datastore 39 for storing data related to the user system 30, including but not limited to data created and/or used by a web browser/application 37. The web browser/application 37 allows the user 9 to communicate with the online banking application 17 or other applications in order to receive suggested specialists 7 or other specialist information. In some embodiments a web browser is used to access websites, applications, or the like; however, in other embodiments a specific application (e.g., mobile application, computer application, or the like) is specifically configured to communicate with the online banking application 17, or other applications described herein. In still other embodiments of the invention portions of other applications may be stored on the user computer systems, such as but not limited to the specialist application 27 that may display information about the specialists 7 to the user on the user computer systems 30.

The specialist computer systems 40 are operatively coupled to the online banking system 10, specialist system 20, user computer systems 30, other financial institution systems 50, or the social networking systems 60 through the network 2. The specialist computer systems 40 have devices the same or similar to the devices described for the user computer systems 30 (e.g., communication device, processing device, memory device with computer-readable instructions, datastore, or the like). Thus, the specialist computer systems 40 communicate with the online banking system 10, specialist system 20, user computer systems 30, other financial institution systems 50, and/or social networking systems 60 in the same or similar way as previously described with respect to the user computer systems 30. The specialist computer systems 40, in some embodiments, are utilized by the specialists 7 to create profiles, access accounts, utilize institution tools, communicate or facilitate communication with the users 9, or the like.

The other financial institution systems 50 are operatively coupled to the online banking system 10, specialist system 20, user computer systems 30, specialist computer systems 40, and/or social networking systems 60 through the network 2. The other financial institution systems 50 have devices the same or similar to the devices described for the online banking system 10, specialist system 20, user computer systems 30, specialist computer systems 40, and/or social networking systems 60 (e.g., communication device, processing device, memory device with computer-readable instructions, datastore, or the like). Thus, the other financial institution systems 50 communicate with the online banking system 10, specialist system 20, user computer systems 30, specialist computer systems 40, and/or social networking systems 60 in the same or similar way as previously described with respect to each system. The other financial institution systems 50, in some embodiments, are comprised of systems and devices that store and access account information or other information within or outside of the bank.

The social networking systems 60 are operatively coupled to the online banking system 10, specialist system 20, user computer systems 30, specialist computer systems 40, and/or other financial institution systems 50 through the network 2. The social networking systems 60 have devices the same or similar to the devices described for the online banking system 10, specialist system 20, user computer systems 30, specialist computer systems 40, and/or other financial institution systems 50 (e.g., communication device, processing device, memory device with computer-readable instructions, datastore, or the like). Thus, the social networking systems 60 communicate with the online banking system 10, specialist system 20, user computer systems 30, specialist computer systems 40, and/or other financial institution systems 50 in the same or similar way as previously described with respect to each system. The social networking systems 60, in some embodiments, are comprised of systems and devices that store and access information for the social networking accounts of users 9, institutions, and the like.

It is understood that the systems and devices described herein illustrate one embodiment of the invention. It is further understood that one or more of the systems, devices, or the like can be combined or separated in other embodiments and still function in the same or similar way as the embodiments described herein.

Any suitable computer-usable or computer-readable medium may be utilized. The computer usable or computer readable medium may be, for example but not limited to, an electronic, magnetic, optical, electromagnetic, infrared, or semiconductor system, apparatus, or device. More specific examples (a non-exhaustive list) of the computer-readable medium would include the following: an electrical connection having one or more wires; a tangible medium such as a portable computer diskette, a hard disk, a random access memory (RAM), a read-only memory (ROM), an erasable programmable read-only memory (EPROM or Flash memory), a compact disc read-only memory (CD-ROM), or other tangible optical or magnetic storage device.

Computer program code/computer-readable instructions for carrying out operations of embodiments of the present invention may be written in an object oriented, scripted or unscripted programming language such as Java, Pearl, Smalltalk, C++ or the like. However, the computer program code/computer-readable instructions for carrying out operations of the invention may also be written in conventional procedural programming languages, such as the “C” programming language or similar programming languages.

Embodiments of the present invention described above, with reference to flowchart illustrations and/or block diagrams of methods or apparatuses (the term “apparatus” including systems and computer program products), will be understood to include that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a particular machine, such that the instructions, which execute via the processor of the computer or other programmable data processing apparatus, create mechanisms for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer readable memory produce an article of manufacture including instructions, which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions, which execute on the computer or other programmable apparatus, provide steps for implementing the functions/acts specified in the flowchart and/or block diagram block or blocks. Alternatively, computer program implemented steps or acts may be combined with operator or human implemented steps or acts in order to carry out an embodiment of the invention.

U.S. patent application Ser. No. ______ to Bertanzetti et al., entitled “Specialist Presentation Through an Online Banking Account,” which is filed concurrently herewith, is hereby incorporated by reference in its entirety. U.S. patent application Ser. No. ______ to Bertanzetti et al., entitled “Specialist Presentation Using a Social Networking Account,” which is filed concurrently herewith, is hereby incorporated by reference in its entirety.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the just described embodiments can be configured without departing from the scope and spirit of the invention. Therefore, it is to be understood that, within the scope of the appended claims, the invention may be practiced other than as specifically described herein.

What is claimed is:

1. A specialist presentation system, comprising:
a memory device; and
a processing device operatively coupled to the memory device, wherein the processing device is configured to execute computer-readable program code to:
identify a trigger for a user;
identify a condition for associating one or more specialists with the user;
identify a specialist based on the trigger and the condition; and
present an indication of the specialist to the user.

2. The specialist presentation system of claim 1, wherein the processing device configured to execute the computer-readable program code to present the indication of the specialist to the user comprises presenting the indication of the specialist in the website in which the user is viewing.

3. The specialist presentation system of claim 1, wherein the processing device configured to execute the computer-readable program code to present the indication of the specialist to the user comprises presenting the indication of the specialist in an application downloaded to a user computer system.

4. The specialist presentation system of claim 1, wherein the processing device configured to execute the computer-readable program code to present the indication of the specialist to the user comprises sending an alert to the user through an application that is at least partially located on a user computer system

5. The specialist presentation system of claim 1, wherein the processing device configured to execute computer-readable program code to identify the condition for associating one or more specialists with the user comprises:
identify a user profile of the user; and
identify a specialist profile of the specialist; and
wherein identifying the specialist is further based on the user profile and the specialist profile.

6. The specialist presentation system of claim 1, wherein the processing device is further configured to execute computer-readable program code to:
receive an indication from the user to view specialist information for the specialist; and
present the specialist information to the user in a specialist profile interface.

7. The specialist presentation system of claim 1, wherein the processing device is further configured to execute computer-readable program code to:
receive an indication from the user to initiate a communication with the specialist; and
notify the specialist of the indication from the user.

8. The specialist presentation system of claim 1, wherein the trigger comprises at least one of receiving a deposit into a user account, reaching a threshold level of net assets, reaching a threshold level associated with the accounts, identifying a search the user is performing within the online banking application, receiving a request for information made by the user, entering stock transactions, identifying a transaction with an institution, or identifying a payment made to another institution.

9. The specialist presentation system of claim 1, wherein the condition comprises at least one of a user location compared to a specialist location, user profile information compared to specialist profile information, social networking contacts of the user associated with the specialist, or expertise of the specialist as it relates to the product in which the user is interested.

10. A computer program product for a specialist presentation system, the computer program product comprising at least one non-transitory computer-readable medium having computer-readable program code portions embodied therein, the computer-readable program code portions comprising:
an executable portion configured to identify a trigger for a user;
an executable portion configured to identify a condition for associating one or more specialists with the user;
an executable portion configured to identify a specialist based on the trigger and the condition; and
an executable portion configured to present an indication of the specialist to the user.

11. The computer program product of claim 10, wherein the executable portion configured to present the indication of the specialist to the user comprises presenting the indication of the specialist in the website in which the user is viewing.

12. The computer program product of claim 10, wherein the executable portion configured to present the indication of the specialist to the user comprises presenting the indication of the specialist in an application downloaded to a user computer system.

13. The computer program product of claim 10, wherein the executable portion configured to present the indication of the specialist to the user comprises sending an alert to the user through an application that is at least partially located on a user computer system

14. The computer program product of claim 10, wherein the executable portion configured to identify the condition for associating one or more specialists with the user comprises:
identify a user profile of the user; and
identify a specialist profile of the specialist; and
wherein identifying the specialist is further based on the user profile and the specialist profile.

15. The computer program product of claim 10, wherein the computer-readable program code portions further comprise:
an executable portion configured to receive an indication from the user to view specialist information for the specialist; and
an executable portion configured to present the specialist information to the user in a specialist profile interface.

16. The computer program product of claim 10, wherein the computer-readable program code portions further comprise:
an executable portion configured to receive an indication from the user to initiate a communication with the specialist; and
an executable portion configured to notify the specialist of the indication from the user.

17. The computer program product of claim 10, wherein the trigger comprises at least one of receiving a deposit into a user account, reaching a threshold level of net assets, reaching a threshold level associated with the accounts, identifying a search the user is performing within the online banking application, receiving a request for information made by the user, entering stock transactions, identifying a transaction with an institution, or identifying a payment made to another institution.

18. The computer program product of claim 10, wherein the condition comprises at least one of a user location compared to a specialist location, user profile information compared to specialist profile information, social networking contacts of the user associated with the specialist, or expertise of the specialist as it relates to the product in which the user is interested.

19. A method for presenting a specialist, comprising:
identifying, by a processing device, a trigger for a user;
identifying, by the processing device, a condition for associating one or more specialists with the user;
identifying, by the processing device a specialist based on the trigger and the condition; and
presenting, by the processing device, an indication of the specialist to the user.

20. The method of claim 19, wherein presenting the indication of the specialist to the user comprises presenting the indication of the specialist in the website in which the user is viewing, presenting the indication of the specialist in an application downloaded to a user computer system, or sending an alert to the user through an application that is at least partially located on a user computer system.
